(19) United States
(12) Patent Application Publication
(10) Pub. No.: US 2007/0124709 A1
(43) Pub. Date: May 31, 2007

(54) Method and system for design rule checking for an SiP device

(76) Inventors: Xiao-Ping Li, Newbury Park, CA (US); Timothy Harding, Newbury Park, CA (US); Andrew M. Kay, Lake Forest, CA (US)

Correspondence Address: WILLIAM J. KOLEGRAFF, 3119 TURNBERRY WAY, JAMUL, CA, 91935, US

(21) Appl. No.: 11/287,767

(22) Filed: Nov. 28, 2005

(51) Int. Cl. G06F 17/50

(52) U.S. Cl. 716/5

(57) ABSTRACT

A method for checking design rules in an SiP (system in a package) design environment is provided. The method uses a commercial computer aided design tool to design and layout out an SiP, that is, to create a design database for the SiP. In the database, characteristics may be assigned to individual instances of components for implementing specific design requirements. Design rules are defined in a rule deck to specify physical, electrical, thermal and manufacturing requirements. The rules can be restrictions on attributes or properties of component instances, or on entities derived from these attributes and properties. The rules can also be comparisons or relationships between polygons generated from layers in component instances. According to the rule deck, the advanced design rule checker operates on the design database, and generates a design rule error list. Design rule errors are managed by an error manager, and should be corrected in the design database. Ideally, the SiP design will be without any design rule errors before being sent to be manufactured.

### BACKGROUND

The field of the present invention is software applications for design rule checking to support the design and development of system-in-a-package (SiP) devices.

Modern electrical design often arranges components to form modular or system-level devices. For example, several integrated circuits, capacitors, filters, amplifiers, matching networks, and other components may be assembled into a single package to operate as a radio device. Often, these modular designs are referred to as a system-in-a-package device, or “SiP”. A typical SiP has a multilayer substrate which provides for mechanical attachment of the various components. Further, the substrate also provides room for electrical interconnection between and among components. In designing an SiP, many design considerations need to be addressed. For example, components must meet minimum spacing requirements, minimum power requirements, and proper thermal requirements. Further, an SiP design often takes into account shielding, grounding, and aesthetic considerations unique to the system.

Computer aided software is readily available for robust design and error checking for integrated circuit designs. Further, more rudimentary design packages are available for SiP designs. However, SiP design has particular requirements not addressed by known commercial design applications. For example, known computer aided design software is only able to perform automatic error checking for relatively simple design constraints. Additionally, known commercial design rule checkers are shape and edge based, which are appropriate for integrated circuit designs but not for SiP designs. Also, it is not unusual that up to 60% of the design constraints and design rules must be manually checked. This level of manual checking is prone to error, is hard to document, is time-consuming, results in long design cycles, and consumes more design resources. It is not unusual that due to the difficulty involved in design rule checking, some rules are not rigorously checked, resulting in manufacturability issues.

### SUMMARY

Briefly, the present invention provides a method for checking design rules in an SiP design environment. The method uses a commercial computer aided design tool to design and layout out an SiP, that is, to create a design database for the SiP. In the database, characteristics may be assigned to individual instances of symbols, elements, or components for implementing specific design requirements. Design rules are defined in a rule deck to specify physical, electrical, thermal and manufacturing requirements. According to the rule deck, the advanced design rule checker operates on the design database, and generates a design rule error list. Design rule errors are managed by an error manager, and should be corrected in the design database. Ideally, the SiP design will be without any design rule errors before being sent to be manufactured.

The advanced design rule checker performs design rule checking employing two methods. In one method, design rules are checked through characteristics of objects (components, connection lines, symbols, etc.) that are stored as attributes or properties of these objects in the design database, or can be derived from such attributes or properties. For example, the width, length, height, angle, type, or even name of the objects can be checked by this method. In the other method, layers in objects are converted to polygons, and design rules are checked by analyzing the polygon properties and relations. For example, dimension, area, space, overlap and enclosure can be checked by this method.

The error manager lists, displays, documents and in general helps a user or designer to understand the design rule errors. The designer may then correct the errors in the design database. In some situations, a design rule error may be allowed in an SiP, and the error manager provides facilities for the user to waive such an error and to explain the reasons for this waive through annotation.

Advantageously, the advanced design rule checker enables a system-in-a-package to be more reliably designed with less manual error checking. Further, the design process and design considerations are better documented, support manufacturability and quality assurance goals.

### BRIEF DESCRIPTION OF THE DRAWINGS

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views. It will also be understood that certain components and details may not appear in the figures to assist in more clearly describing the invention.

FIG. 1 is a block diagram of a software process for applying advanced design rule checking to a system-in-a-package device in accordance with the present invention.

FIG. 2 is a flowchart of a process for applying advanced design rule checking to a system-in-a-package device in accordance with the present invention.

FIG. 3A is a flowchart of a process for applying advanced design rule checking to a system-in-a-package device in accordance with the present invention.

FIG. 3B is a flowchart of a process for applying advanced design rule checking to a system-in-a-package device in accordance with the present invention.

FIG. 4 is a flowchart of a process for managing errors found in a system-in-a-package design in accordance with the present invention.

FIG. 5 is a block diagram of a software process for applying advanced design rule checking to a system-in-a-package device in accordance with the present invention.

FIG. 6 is a flowchart of a process for applying advanced design rule checking to a system-in-a-package device in accordance with the present invention.

FIG. 7 is a flowchart of a process for applying advanced design rule checking to a system-in-a-package device in accordance with the present invention.

FIG. 8 is a flowchart of a process for managing errors generated by the application of design rule checking to a system-in-a-package device in accordance with the present invention.

FIG. 9 is a flowchart of a process for applying advanced design rule checking to a system-in-a-package device in accordance with the present invention.

### DETAILED DESCRIPTION

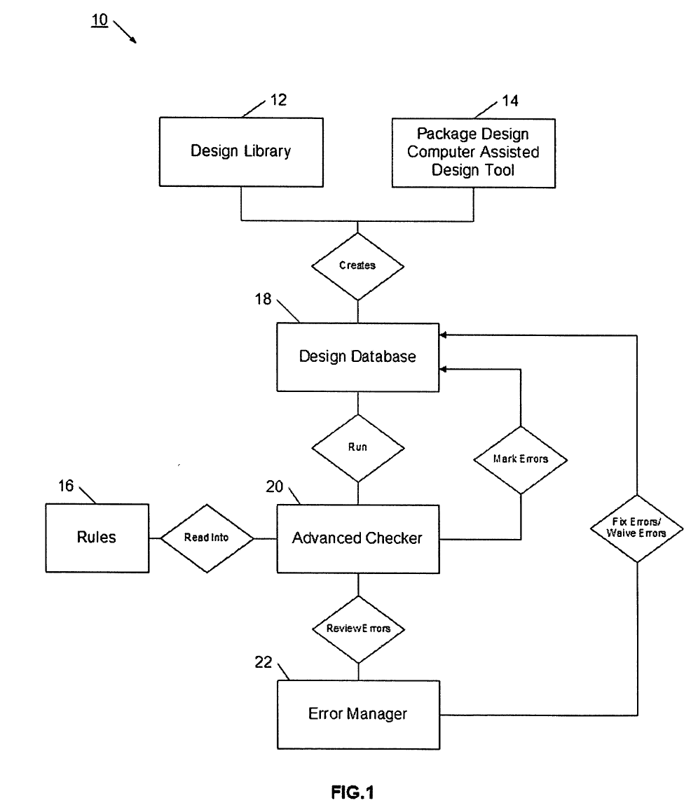

Referring now to FIG. 1, a method for design rule checking is illustrated. Method 10 particularly illustrates a method for design rule checking applied to the design of a system-in-a-package (SiP) device. An SiP device typically has a substrate on which multiple discrete components are positioned. These discrete components may be, for example, several integrated circuits, capacitors, filters, amplifiers, matching networks, and other components. These discrete components may be soldered to the substrate, or may be attached through a surface mount technology. It will be appreciated that other methods of mechanically attaching the discrete components may be used.

The substrate also provides for electrical connection between components. In this way, the substrate provides electrical paths, traces, and pads between components, as well as allows for power, shielding, and grounding considerations. Each component placed on the substrate has its own electrical and mechanical requirements. These requirements may include spacing, heat dissipation, mechanical attachment requirements, electrical attachment requirements, or other specific characteristics. Further, the SiP design also may have particular package-level design features or considerations. For example, some system designs may require that all RF components be placed within a particular area of the package that is particularly well shielded. In another example, selected components may be required to be placed in a particular area for meeting heat dissipation criteria. Also, components must be placed on the substrate in a way that facilitates efficient and robust electrical connections between components, and supports the reliable manufacturing and reliability of the overall package system

Due to the many design considerations unique to the SiP device, it has been found that known computer aided design software tools are effective only in initial design and for generally verifying design reliability. Accordingly, a software computer aided design tool is used to generally layout and design the SiP. The design package 14 may be, for example, an off-the-shelf software package such as the Allegro Package Designer™ software application provided by Cadence®. An experienced designer uses the computer aided design tool to generally layout a SiP design, including component physical and electrical layout. The design package 14 also has an associated design library 12, which includes descriptions for symbols, elements, and components used by the design package 14. The items in the design library 12 may be provide by component suppliers customized to the needs of the designer's company, and may be supplemented by the designer.

A designer used the computer aided design tool 14 and the design library to create a design database 18, which includes physical and electrical definitions for the overall design as well as individual elements or components. The design package 14 may have some design checks available, but fails to adequately check for SiP-specific criteria. To address these SiP specific criteria, an advanced checker 20 is run, which uses the information in the design database, and performs additional SiP design checks and verifications. The advanced checker 20 may be a separate standalone application, or may be a module operating in conjunction with the computer aided design tool 14. The advanced checker 20 has a set of rules 16 which more specifically relate to SiP design properties. In one example, the set of rules 16 is provided as a rule deck, and each rule is read into the advance checker as needed. In this way, the advance checker advances through a set of rules, and methodically and systematically makes design checks and verifications. The rule deck further comprises individual rules, with each individual rule being associated with a particular component or symbol in the design database. In another example, a rule in the deck may relate to an overall design consideration that encompasses several components, elements, or symbols. In this way, a rule deck may be efficiently assembled by selecting components or symbols present in the SiP design, and may flexibly be adjusted for specific design needs.

The rules 16 may be applied to the components and symbols extracted from design database 18. In some cases the advanced checker not only has rules for individual elements and components, but is configured to generate polygon representations of a library item or several items. If polygon generation is supported in the advanced checker, then some of the rules 16 may support comparison of polygons. In this way, symbols, elements, or components may be converted to a polygon representation, and additional constraints or requirements may be embodied in the polygon or between polygons. For example, a connection line symbol may be converted to a polygon that considers an additional length or width for the connection line. This can be useful for increased robustness of electrical connection, or for providing for less crosstalk between connection lines. In another example, multiple symbols may be aggregated into a single polygon. By treating multiple symbols as a single polygon, simplified checking and layout may be enabled.

Once the rules and the advanced checker have generated polygon representations of at least some of the symbols, the polygons may also be compared for rule violations. In this way, polygons may be confirmed to sufficiently overlap or have sufficient separation on a single layer, or may be compared for proper physical relationship between or among layers. In a specific example, it may be desirable to confirm that a set of polygons representing RF components are all within a polygon boundary having increased RF shielding.

The advanced checker 20 applies the rules 16, and generates a list of errors. In some cases, particularly with relatively simple errors, errors will be marked in the design database, and may be corrected by using the design package 14. In other cases, additional designer review and analysis is required, so an error manager is used to assist in fixing and reporting these errors. The error manager 22 is used to allow the designer to further investigate, review, and annotate errors in the list of errors. For example, errors may be viewed by a browser application, which may be a separate software application, or may be a module operating in conjunction with the advanced checker 20. The browser may display the list of errors, and enable details for each error to be viewed individually. More particularly, when a specific error is selected for investigation, the browser may graphically displays the specific design layer or layers where the error is embodied. In another example, the browser not only may present symbols, elements, and components, but may present polygon information as generated by the advanced checker 20.

The designer uses the error manager and browser function to identify root cause of errors, and make or suggest fixes or adjustments to the SiP design. Typically, the designer uses the design package 14 to make the corrections in the design database, and then re-runs the rule deck on the corrected design database 18. This iterative process allows the designer to fix almost all errors, and to make adjustments and improvements to the design and rules.

As the designer views each error, the designer is able to provide annotation for that error. This annotation is typically textual in nature, and becomes associated with the error in the error list in the error manager 22. The annotation may also include selection items, drop down boxes, check boxes, and the like, as well as free-form entry. In one example, the designer may identify an error as being a false error. The designer may waive the error with a proper annotation so that on the next pass through the error checking process, the flag error is ignored. In another example, the designer may recognize an error as being a valid error found by the advanced checker 20, but make a design choice to accept the error. The designer would further annotate this acceptance, so that those later viewing the design would understand an experienced designer has acknowledged and waived the particular error. By enabling a designer to mark errors as waived or unwaived, and further allowing a designer to annotate those decisions, a robust reporting function is enabled. In this way, reports may be generated that identify all errors, and further identifies which errors are outstanding to be fixed, and display errors that have been accepted by the designers. Further, the acceptance has been documented and confirmed for compliance and reliability purposes.

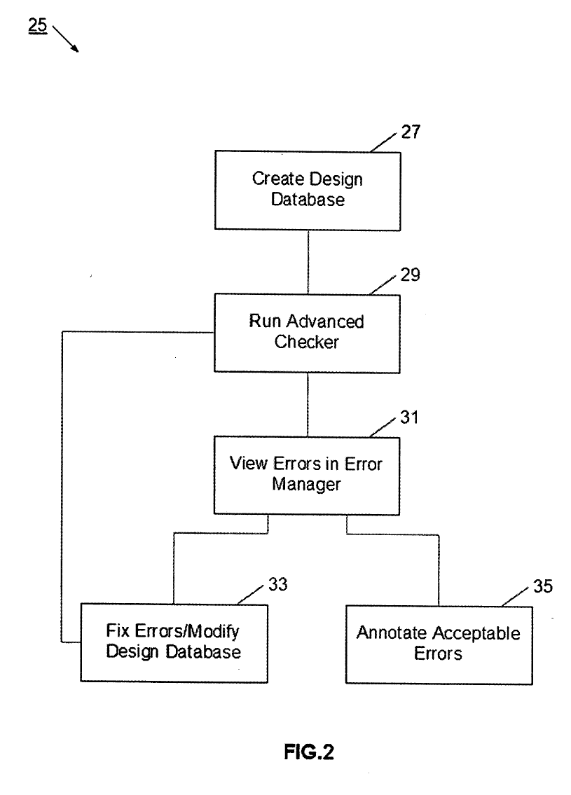

Referring now to FIG. 2, the general process 25 that a designer uses to verify an SiP design is illustrated. Process 25 shows that a designer creates a design database as shown in block 27. The design database may be generated using an off-the-shelf design package, which may cooperate with a standard or modified design library. Since the off-the-shelf package has limitations in its ability to handle SiP issues, the designer runs an advanced checker on the design as shown in block 29. The advanced checker applies additional rules useful to SiP design and verification, and may include rules of individual components, symbols, and elements, as well as rules applied to multiple items. The advanced checker has an associated error manager process that the designer uses to review and document errors identified by the advanced checker, as shown in block 31. Most often, the error manager is used to identify errors to be fixed by correcting the design, as shown in block 33. In some, but relatively rare occasions, the designer may annotate an error as acceptable as shown in block 35. By allowing the annotation of acceptable or waived errors, the design review process is simplified, and a more robust documentation trail is established.

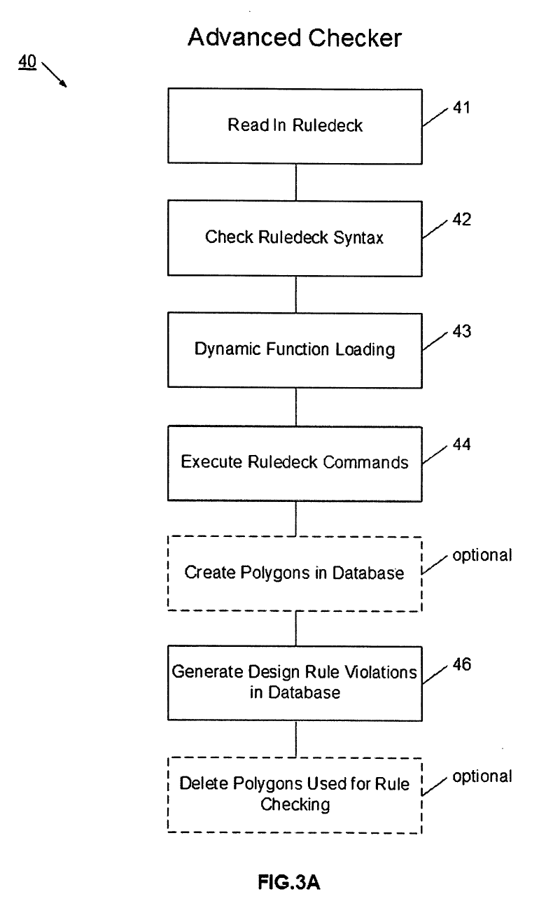

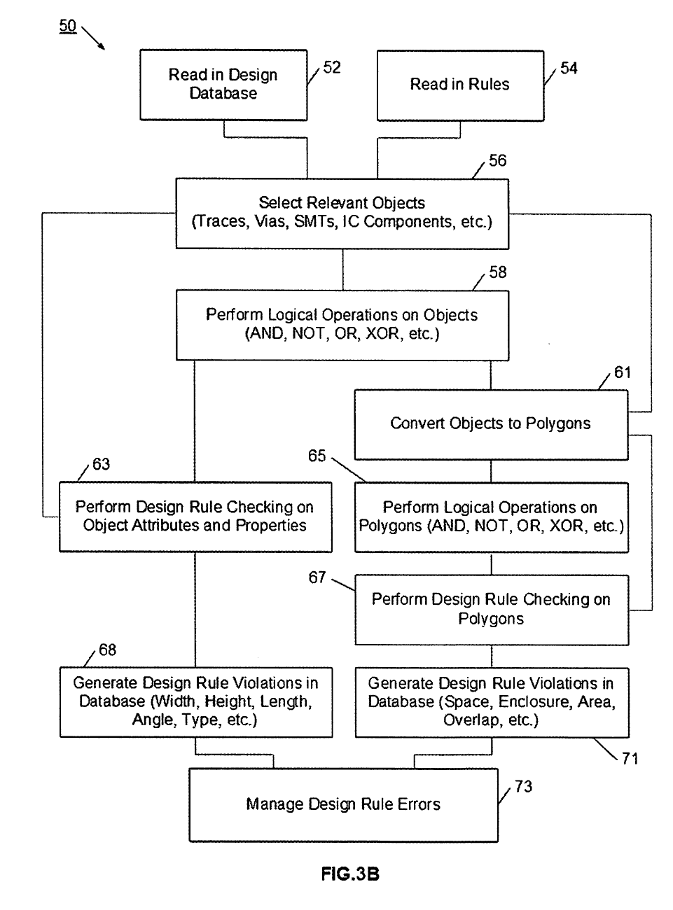

Referring now to FIG. 3A, an overview of an advanced checker 40 is illustrated. The advanced checker first reads in the design rules which may be defined in a file as a rule deck, as shown in block 41. The syntax of each statement in the rule deck is checked to make sure that the advanced checker understands the rules and the tasks to be performed, as shown in block 42. If the rules are not properly written, the advanced checker prints out where and what is wrong and what is expected, which can be very helpful for the person who develops the rule decks. Based on the set of rules, all the software necessary to perform the required tasks are dynamically loaded into the computer memory, as shown in block 43.

The advanced checking process 40 then executes the rule deck commands as shown in block 44, typically proceeding sequentially through the rules. Some rules may be directly applied to elements and structures within the design database. In other cases, the elements or structures in the design database are manipulated prior to the application of a rule. Design rule violations, if any, are identified and written into the design database, as shown in block 46

Referring now to FIG. 3B, a process for advanced checking 50 is illustrated. The advanced checker process 50 has a design database 52, which may have been generated using an off-the-shelf design package. In this way, the design database 52 has a description of a particular SiP design. A set of rules 54, typically in the form of a rule deck, have been selected for the SiP design embodied in the design database. By using a rule deck, a designer may easily select the appropriate rules and system constraints to apply to a particular manufacturing process or family of products. Generally, a rule in a rule deck typically is arranged to identify a particular element, symbol, or component that the rule is to be applied to, and then specifies particular constraints. These constraints may be, for example, to verify proper spacing, proper electrical contact, or proper placement. When applying the rule, an initial step is identifying the particular element in the design database to which the rule applies. For example, block 56 shows that the design database 52 is interrogated to locate the element which is the subject matter of a particular rule. In some cases, the appropriate element may be directly found in the design database, and its attributes or properties checked as shown in block 63. For example, a grounding line may be required to have a minimum width. Such a constraint may be verified by directly interrogating each grounding line found in the design database.

Other elements may require an additional selection step as shown in block 58. In this regard, a rule may be applied to only a subset of a particular type of element. For example, a particular rule may only apply to microvias defined on layer one and two. To identify these microvias, all the vias may be identified in the design database, and a logical operation is performed to identify only the vias extending from layer 1 to layer 2, but not to any other layers. After the specified microvias have been identified, then the object attributes and properties of the microvia rule may be applied as shown in box 63.

Some types of attributes or properties are difficult to directly check in the design database. For example, connection lines are typically identified in the design database according to a length and centerline. In order to check spacing between connection lines, a relatively complex mathematical comparison must be made, especially when the connection lines are not in parallel. In another example, it is reasonably difficult to confirm proper overlap of certain elements, or to confirm that all elements are within a particular area. Accordingly, some rules do not act directly on an individual element, but act on a polygon representation of one or more elements. To apply such a polygon rule, selected elements in the design database are converted to a polygon representation, as shown in block 61. In this way, an elemental definition of the design database is converted into a geometric shape. Such a shape is defined by its vertices and edges. This more complete geometric shape may then be used to perform advanced comparisons. Some polygons may be directly checked as shown in block 67. For example, a polygon may be checked for a minimum area, sufficient overlap with another polygon, proper enclosure by another polygon, or for proper spacing between polygons.

Sometimes, logical operations are used to more specifically identify a particular polygon as shown in block 65. Take for example a rule that applies to capacitor spacing when the capacitor is used in an RF circuit. The overall design may have a polygon defined for the RF area, and each capacitor may also be identified with a polygon. Therefore, a logic operation could easily identify all capacitors operating within the RF area. A rule may then apply particular constraints or other attributes on the selected subsets of polygons as shown in block 67. Whether on elements, or on polygons, design rule violations are generated and stored in the database, as shown in blocks 68 and 71. The offending elements that contribute to the violations are identified and stored together with the violations. The design rule violations are then handled by an error manager as shown in block 73.

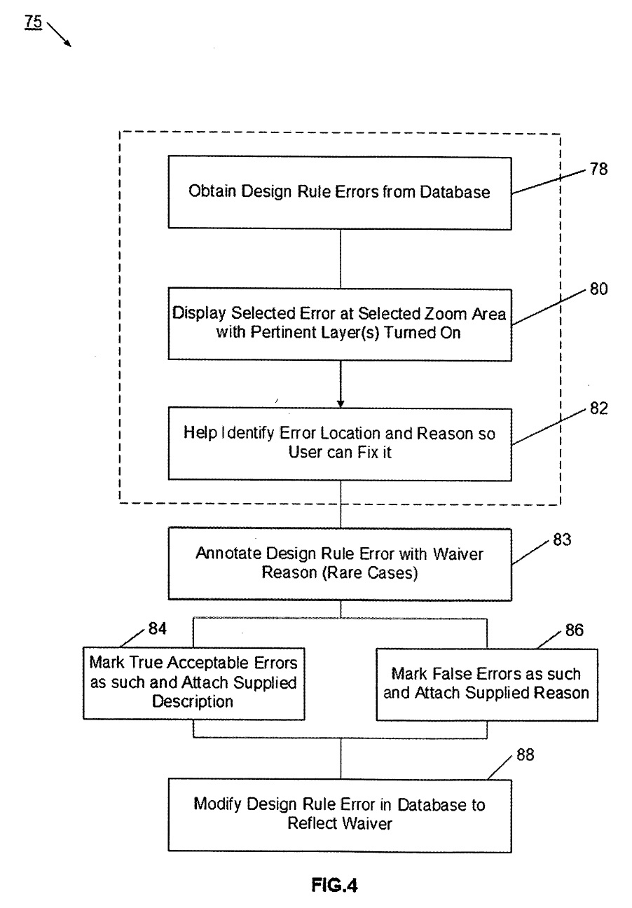

Referring now to FIG. 4, a process for managing errors 75 is illustrated. Process 75 has a database or list of errors 78 that has been generated by an advanced design rule checker. The design rule checker may be, for example, an advanced checker as described with reference to FIG. 3B. The error process 75 allows a designer to select one or more errors from the database of errors, and graphically view 80 the layer or layers and elements implicated by the error. In the viewing process, the designer may zoom and pan to areas of interest, and may turn layers on and off to assist in viewing and understanding the error. In this way, the error manager 75 and the graphical browser enable the designer to identify the cause of an error, and propose or implement fixes to the SiP design, as shown in block 82. When the designer has reviewed and understood the error, the designer may, in some relatively rare cases, waive or accept the error 83. This may happen, for example, In and experimental design that pushes the manufacturing limits. These are true errors, but the designer has accepted the error and described the reason for acceptance, as shown in block 84. However, in most cases, the designer will attempt to eliminate the error, which may entail adjusting or correcting the SiP design. To assist in correcting the error, the designer may annotate the error with textual or selected messages. These messages and text may be useful at a later time, or to others, in understanding and fixing the errors.

In some cases, an error in the error database may be a false error as shown in block 86. That is, the rule identifies an error in the design, but no design error actually exists. This may happen, for example, if a rule is incorrectly defined, or if the constraints for a rule are too closely set. For such false errors, the designer may annotate the error as being false 86, which may facilitate correcting the underlying rule at a later time. Again, the annotation of the false error provides a valuable documentation trail for the SiP design process. Accepted or waived errors are documented in the design database as shown in block 88. Theses messages and text provide a valuable documentation trail for the SiP design.

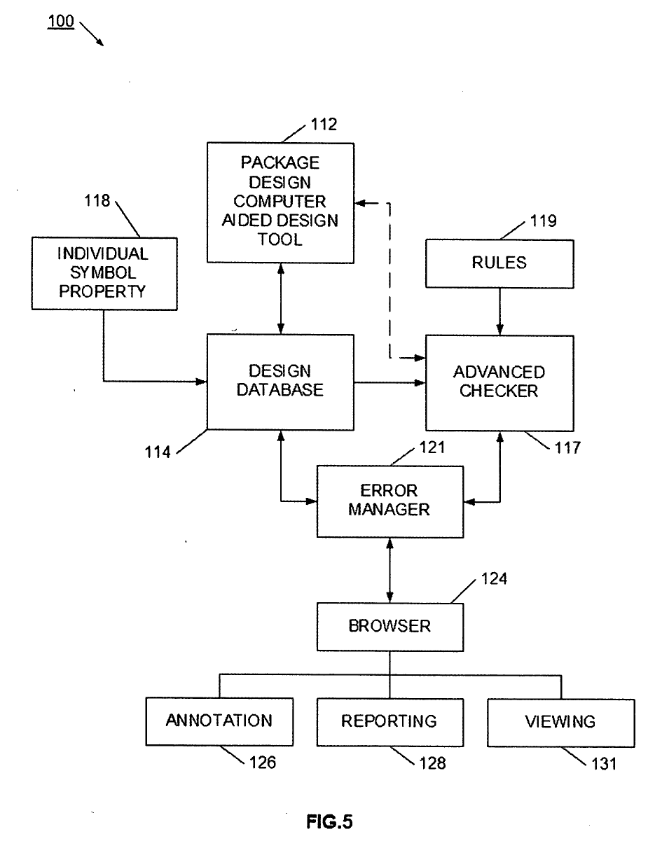

Referring now to FIG. 5, a method 100 for design rule checking is illustrated. Method 100 particularly illustrates a method for design rule checking applied to the design of an SiP device. Due to the many design considerations unique to the system-in-a-package device, it has been found that known computer aided design software tools are effective only in initial design and for generally verifying design reliability. Accordingly, a software computer aided design tool is used to generally layout and design the SiP. The design package 112 may be, for example, an off-the-shelf software package such as the Allegro Package Designer™ software application provided by Cadence®. An experienced designer uses the computer aided design tool to generally layout an SiP design, including component physical and electrical layout.

The computer aided design tool 112 generates a design database 114, which includes physical and electrical definitions for the overall design as well as individual elements or components. An advanced checker 117 is configured to extract information from the design database, and perform additional design checks and verifications. The advanced checker 117 may be a separate standalone application, or may be a module operating in conjunction with the computer aided design tool 112. The advanced checker 117 has a set of rules 119 which more specifically relate to SiP design properties. In one example, the set of rules 119 is provided as a rule deck. The rule deck further comprises individual rules, with each individual rule being associated with a particular component or symbol in the design database. In another example, a rule in the deck may relate to an overall design consideration that encompasses several components, elements, or symbols. In this way, a rule deck may be efficiently assembled by selecting components or symbols present in the SiP design, and may flexibly be adjusted for specific design needs.

The elements, symbols, and components generated by design package 112 may need to be extended by allowing for individual symbol property 118. Using the individual symbol property 118 function, features specific to the SiP design process may be easily added. For example, properties can be added that specify height, power, or heat requirements for an element.

The rules 119 may be applied to the components and symbols extracted from design database 114. Further, the rules 119 may provide for the generation and comparison of polygons. In this way, symbols, elements, or components may be converted to a polygon representation, and additional constraints or requirements may be embodied in the polygon or between polygons. For example, a connection line symbol may be converted to a polygon that considers an additional length or width for the connection line. This can be useful for increased robustness of electrical connection, or for providing for less crosstalk between connection lines. In another example, multiple symbols may be aggregated into a single polygon. By treating multiple symbols as a single polygon, simplified checking and layout may be enabled.

Once the rules and the advanced checker have generated polygon representations of at least some of the symbols, the polygons may also be compared for rule violations. These rule violations may be applied on a single layer of the substrate, or may be applied between or among layers. In this way, polygons may be confirmed to sufficiently overlap or have sufficient separation on a single layer, or may be compared for proper physical relationship between or among layers. In a specific example, it may be desirable to confirm that a set of polygons representing RF components are all within a polygon boundary having increased RF shielding.

Once the advanced checker 117 has applied the rules to individual symbols and to polygons, a list or database of errors is generated. The errors are managed by an error manager 121. The error manager may cooperate with a browser application 124, which enables graphically reviewing one or more selected errors. The browser application 24 may be a separate software application, or may be a module operating in conjunction with the advanced checker 117. The browser 124 preferably displays the list of errors, and enables details for each error to be viewed individually. More particularly, when a specific error is selected from the error database, the browser graphically displays the specific area in the substrate where the error is embodied, as shown in block 131. This area may be on a single layer, or may be caused by a relationship between layers, so multiple layers will be viewed. The operator is allowed to activate and deactivate layers and elements to aid in identifying the location, severity, and cause of the error. In order to enable such viewing, the browser may cooperate with the design database 114 or computer-aided design tool 112 directly, or may have a reader application for generating its own viewable layers. In another example, the browser not only may disclose symbols as represented in the design database 114, but may display polygon information as generated by the advanced checker 117.

As the designer views each error, the designer is able to provide annotation for that error, which may assist in fixing or correcting the cause of the error. Sometimes, the cause of the error may be an actual design error, and in other cases the rule may need to be corrected. The annotation is typically textual in nature, and becomes associated with the error in the error list. The annotation may also include selection items, drop down boxes, check boxes, and the like, as well as free-form entry. In most cases, the designer will mark errors for repair or correction, so errors will be eliminated in subsequent passes through the advanced checker.

However, in some cases, the designer may identify an error as being a false error. The designer may mark the error with a proper annotation so that on the next pass through the error checking process, the flag error is ignored. In another example, the designer may recognize an error as being a valid error found by the advanced checker 117, but make a design choice to accept the error. The designer would further annotate this acceptance, so that those later viewing the design would understand an experienced designer has acknowledged and waived the particular error. By enabling a designer to mark errors as waived or unwaived, and further allowing a designer to annotate those decisions, a robust reporting function 128 is enabled. In this way, reports may be generated that identify all errors, and further identifies which errors are outstanding to be fixed, and display errors that have been accepted by the designers. Further, the acceptance has been documented and confirmed for compliance and reliability purposes.

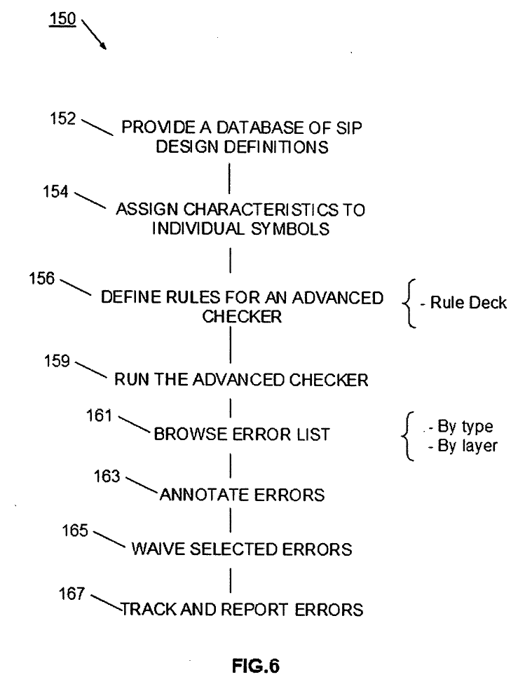

Referring now to FIG. 6, a method for design rule checking an SiP device is illustrated. Method 150 provides a database of the SiP design definitions as shown in block 152. These design definitions typically are generated by a computer aided design system, and generally define component electrical and physical arrangements. Characteristics may be set or adjusted for individual symbols, elements, or components, or may be used to adjust a system-level constraint. In some cases, the database of design definitions may need to be supplemented with additional elements or information specific to the SiP design. These characteristics may include defining polygon relationships or connection line properties, or a standard component may be adjusted according to its particular operating environment. In this way, particular characteristics may be defined individually for each of the symbols or elements.

A set of rules is designed for an advanced checker as shown in block 156. In a particular implementation, the advanced checker uses a rule deck for receiving individual rules. Each individual rule relates to a particular type of component or element in the SiP device, so a rule deck represents the aggregated collection of elements and components in the design. Rules in the rule deck may also be set for system-level considerations and constraints. Rules may also be set for polygon representations, which enables some types of checks to be more efficiently performed. In applying a polygon rule, one or more elements are retrieved from the design database and converted to a polygon representation, and then the polygon is checked for compliance with the relevant rule. The rules 156, in conjunction with the advanced checker, are used to confirm design properties and attributes that apply to symbols, elements, components, polygons, or system modules.

The advanced checker is run as shown in block 159. The advanced checker applies the rules to the symbols, elements, components, and polygons, and generates a list of errors. A browser is used to review the error list as shown in block 161. These errors may be viewed by type, by layer, or by severity. In one particular implementation, the browser enables each error to be viewed separately. When each error is selected, a graphical representation of the error may be provided. The graphical illustration may show an individual layer or a set of layers where the error has occurred. In another example, the error is displayed with both symbol information and polygon information. In this way, the designer may more readily understand why the advanced checker identified a particular error.

The designer may then mark each error as being waived or not accepted as shown in block 165. An unaccepted error would be flagged and reported for repair or further design consideration. A waived or accepted error may be annotated as being a real error or a false error as shown in block 163. A false error is an error that was identified by the advanced checker, but has been identified due to a faulty configuration or application of a rule. Accordingly, it may be desirable to correct the particular rule so that this error does not appear in the future. However, the designer may choose not to delay the substrate design while the rule is fixed and verified, but may simply annotate the error as being a false error. In another example, the designer may leave the faulty rule, and accept the fact that a particular rule over includes errors. In some cases, this over-inclusion may be desirable for intentionally over designing or providing additional engineering margin.

In some cases, a designer may choose to accept a real error. Using the designer's experience and expertise, the designer may make a choice that the overall SiP design will reliably operate even with an actual error as identified by the rules. The designer is able to annotate this decision to accept the error, and mark the error as accepted. In this way, someone in a design review process would be able to identify an error as having been previously waived by an experienced design engineer. This level of documentation 167 significantly improves design review processes, as well as providing substantial documentation for quality assurance purposes.

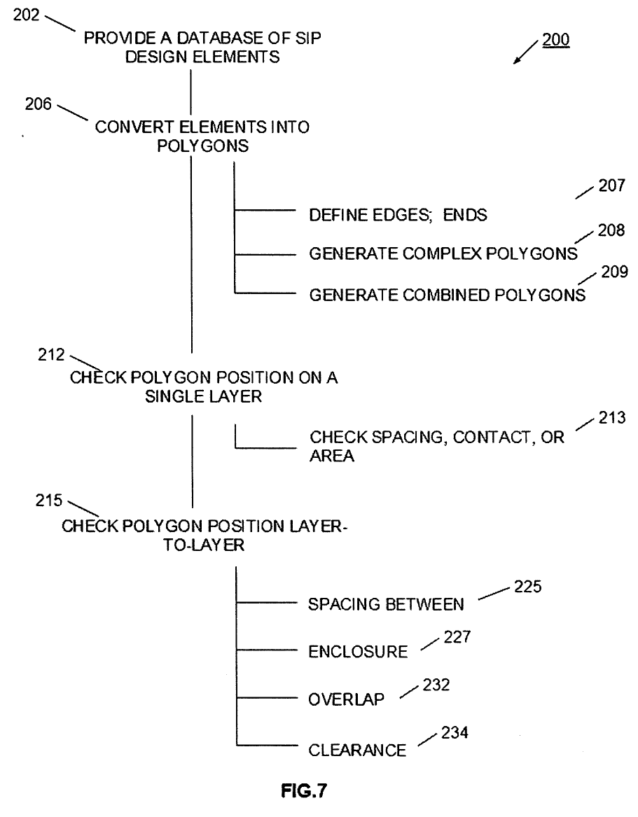

Referring now to FIG. 7, a method for design rule checking is illustrated. Method 200 provides a database of SiP design elements as shown in block 202. These design elements may include symbols or components used in designing a multilayer substrate for an SiP design. Typically, the database of design elements has been generated by a computer aided design program operated by a designer. Method 200 converts elements in the database into polygons as shown in block 206. More particularly, individual elements or symbols may be converted to polygons, or a number of symbols and elements may be combined into a single polygon. Polygons may also represent elements or symbols on a single layer, or may represent elements and symbols on multiple layers.

Rules may be established for the formation of these polygons. For example, polygons may be defined that give a particular component defined vertices and edges, as shown in block 207. By more particularly defining a geometric shape, size, location, and spacing comparisons may be more easily made. A polygon may be used to represent the actual shape of the component in the design database, or may itself be generated according to more complex shape rules, as shown in block 208. For example, a connection line polygon may be defined to have an extra width to accommodate manufacturing tolerances, or the ends of lines may be rounded to more closely resemble the finished product. Polygons may also be combined together as shown in block 209, or may be formed as an aggregation of individual symbols and elements. Rules may be applied to these combinations, as well as the individual polygons, so that design rules may be applied at different levels of abstraction or granularity. This allows polygon-level checking at the symbol, element, component, module, and system layout configurations.

Once the polygons have been generated, the system may perform comparisons between polygons, and between polygons and individual symbols and elements. As shown in block 212, the method may check polygon position or attributes on a single layer. These checks may include spacing, sufficient contact surface, or area measurements as shown in block 213. The checks may also be more complex, for example, counting that an IC has the right number of pad connectors, and that each pad connector is of a sufficient size. In another example example, the number of segments may be counted in a connection line. This may be useful in setting the maximum number of segments for a particular connection line, or may be used to count the number of pins attached to a particular segment line.

The polygons may also be compared for layer to layer relationships as shown in block 215. For example, one polygon may represent a wire bond pad and another polygon may represent an integrated circuit die position. By performing a layer to layer comparison, the system can assure that the appropriate wire bond pad is positioned over the die. In another example, the layer to layer comparison may determine the wire bond angle for device connection. This angle is important to assure wire bond machinery can reliably make a wire bond attachment. Spacing between polygons may also be determined as shown in block 225. The spacing may be determined on an individual layer basis, or may be checked between layers. In another example, layer to layer comparisons may be made to assure an enclosure of one or more polygons by another larger polygon as shown in block 227. This may be required so that a set of pads are assured to be within a die area, or so that polygons representing multiple RF components are assured to be placed in an RF shielded area.

Overlap between polygons may also be compared as shown in block 232. Overlap is important, for example, to assure that proper electrical connections may be made layer to layer. In another example, overlap may be required to assure proper grounding or shielding. Clearance of polygons may also be verified as shown in block 234. For example, a particular integrated circuit may have a specific height, and the IC must be verified to fit vertically within the available SiP volume.

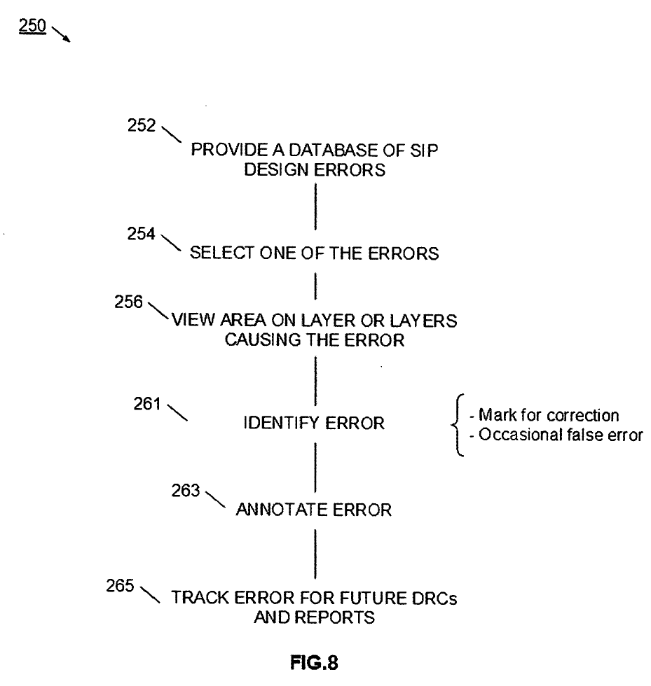

Referring now to FIG. 8, a method for design rule checking is illustrated. Method 250 starts by providing a database of SiP design errors as shown in block 252. These design areas typically have been generated by an advanced checker applying a set of rules to an element or symbol database. Method 250 allows one of the errors to be selected as shown in block 254. Upon selecting one of the errors, method 250 displays a single layer or a set of layers embodying the design area as shown in block 256. For example, if two symbols are required to overlap but do not, the particular layer or layers showing the lack of overlap may be displayed. The display may present symbols, elements, components, or polygon representations. The designer may review the error, both textually and graphically, to determine if the error is acceptable in the particular design.

As shown in block 261, the designer may choose to mark the error as acceptable. This could be, for example, because the error is a false error generated by a wrong design rule. In another example, the error may be an acceptable or permitted error, based on the designer's expertise and the particular application requirements of the SiP design. The designer may then annotate the error as shown in block 263 to facilitate more efficient design review. For example, if the designer finds that the error is acceptable, the designer may add an explanation of why the error is being waived, so that future design review personnel are assured that the error was fully considered. By accumulating the annotation information, a robust and complete historical documentation is compiled for the design of a SiP as shown in block 265. In this way, improved quality assurance processes and reliability processes may be supported.

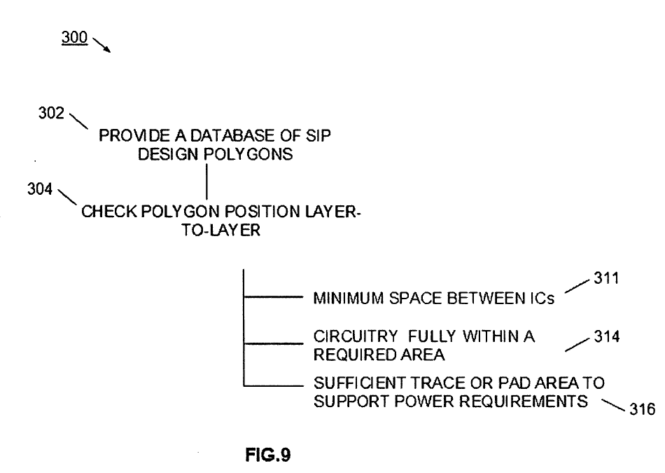

Referring now to FIG. 9, a method 300 for design rule checking is illustrated. The design check is being done on a system-in-a-package device design. More particularly, the check is for confirming the design of the multilayer substrate providing mechanical and electrical connections for the components and elements comprising the system-in-a package device. Method 300 provides a database 302 of polygon information representing symbols, elements, components, or system-level constraints for a system-in-a-package design. The database 302 may also include polygons that represent collections of polygons, and may also have polygons that represent items on multiple layers. The database 302 of polygons may have been generated from a description file output from a computer aided design program. A set of polygon rules were applied to the descriptions, with the descriptions providing for constraints and design considerations unique to the system-in-a-package device.

Once generated, the polygons could be compared to expected positioning, for example, on a single layer. In a more advanced check, the polygons could be checked for layer to layer positioning, as shown in block 304. The layer-to-layer comparison is useful, for example, to verify spacing between components on different layers 311, or to assure that a type of circuitry is fully within a required area 314. In a final example, the size of traces, pads, or electrical connect area are confirmed to be of sufficient size to support power, grounding, or shielding requirements 316. Of course, it will be appreciated that polygon comparisons may be made for many other useful purposes.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A method for checking design rules, comprising:
using a computer aided design tool to lay out an SiP substrate design;
generating a database of design definitions indicative of the SiP substrate design;
defining design rules for an advanced design rule checker;
applying the design rules to the SiP design definitions using the advanced design rule checker;
finding errors in the application of the design rules to the SiP design; and
viewing the violations.

2. The method according to claim 1, further including the steps of:
generating the database to include polygon design rules; and
generating a polygon representation of at least one design element;

3. The method according to claim 1, wherein the step of defining the rules includes the step of defining a rule deck.

4. The method according to claim 1, wherein the advanced design rule checker allows a user to select a rule deck, and perform tasks specified in the rule deck.

5. The method according to claim 2, further including:
performing checks on object rules through object attributes and properties, and entities derived from these attributes and properties; and
performing checks on polygon rules by analyzing relationships between polygons generated from layers in objects.

6. The method according to claim 5, wherein object rule checking comprises:
selecting objects from the design database;
performing logical operations on the objects to identify a set of objects of interest;
comparing the identified objects to conditions in the design rule;
creating a design rule error if the comparison violates the condition specified in the design rule; and
identifying objects that contribute to the design rule error.

7. The method according to claim 6, wherein the objects are selected from the group consisting of integrated circuits, surface mount devices, traces, vias, and shapes.

8. The method according to claim 6, wherein the logical operations on objects are selected from the group consisting of: and; or; not; xor; inside and are; outside an area; with a predefined attribute or property; and connected to a predefined objects.

9. The method according to claim 6, wherein attributes of objects are selected from the group consisting of: the size of an integrated circuit; the position of a surface mount device; the vertices of a trace; the width of a trace segment; the angle of an oblong-shaped via and the area of a shape.

10. The method according to claim 2, further including the steps of generating another polygon, and assigning a minimum overlap requirement between the two polygons.

11. The method according to claim 2, further including the steps of generating another polygon, and assigning a requirement that one of the generated polygons be enclosed by the other one of the generated polygons.

12. The method according to claim 5, wherein polygon rule checking comprises:
selecting objects from the design database and performing logical operations on these objects;
converting layers in the selected objects into polygons;
performing logical operations on the polygons to form complex polygons that are necessary for checking certain design rules;
analyzing relationships between the polygons;
comparing the relationships between the polygons with those specified by the design rule;
creating a design rule error if the comparison violates the condition specified in the design rule; and
identifying the objects that contribute to the design rule error.

13. The method according to claim 12, wherein logical operations on polygons are selected from the group consisting of: and, or, not, xor, expand, shrink, inside an area, not inside an area, enclosed, not enclosed, interact with another polygon, not interact with another polygon, contain a predefined object, and not contain a predefined object.

14. The method according to claim 12, wherein the relationships between polygons can be space, overlap, or enclosure.

15. The method according to claim 1, further including the steps of:
viewing the errors in an error list;
selecting an error from the error list;
automatically displaying the layer and area in the layer causing the selected error;
marking the selected error as waived or unwaived; and
annotating the error with an additional textual descriptions.

16. A method of designing a substrate for a SiP, comprising:
providing a database definition for the substrate;
defining a plurality of symbols within the database;
generating a plurality of polygons representative of at least some of the symbols;
providing a set of design check rules that includes symbol rules and polygon rules; and
generating an error list by applying the design check rules to the symbols and polygons.

17. The method according to claim 16, further including the steps of:
selecting one error from the error list; and
automatically displaying the layer and area in the layer causing the one error.

18. The method according to claim 17, further including the steps of:
marking one of the errors as waived; and
annotation the marked error with an additional textual descriptions.

19. The method according to claim 16, further including the step of comparing one polygon to another polygon.

20. The method according to claim 19, wherein the comparison determines that a wirebond polygon has sufficient overlap with a via polygon.

21. The method according to claim 19, wherein the comparison determines that there is sufficient spacing between a first IC polygon and a second IC polygon.

22. The method according to claim 19, wherein the comparison determines that a circuit polygon is within a required area polygon.
